(19) United States
(12) Patent Application Publication
(10) Pub. No.: US 2003/0177491 A1
(43) Pub. Date: Sep. 18, 2003

(54) Audio/video device connection with a printer for printing documents

(76) Inventors: Chet M. Butikofer, Meridian, ID (US); Cori A. Schaefer, San Diego, CA (US)

Correspondence Address: HEWLETT-PACKARD COMPANY, Intellectual Property Administration, P.O. Box 272400, Fort Collins, CO, 80527-2400, US

(21) Appl. No.: 10/100,201

(22) Filed: Mar. 13, 2002

(51) Int. Cl. G06F 3/00

(52) U.S. Cl. 725/37

(57) ABSTRACT

This invention relates to an audio/video device that is connected to a printer for printing documents. Such structures of this type, generally, allow the user to print documents, such as, advertisements, coupons, discounts, rebates, lyrics, scripts, closed captioning, and a list of similar products and/or services which are associated with the audio/video programming that the user is listening to and/or viewing.

### FIELD OF THE INVENTION

This invention relates to an audio/video device that is connected to a printer for printing documents. Such structures of this type, generally, allow the user to print documents, such as, advertisements, coupons, discounts, rebates, lyrics, scripts, closed captioning, and a list of similar products and/or services which are associated with the audio/video programming that the user is listening to and/or viewing.

### DESCRIPTION OF THE RELATED ART

It is known, in the advertising art, to employ interactive advertising. Exemplary of such prior art are U.S. Pat. No. 6,188,398 ('398) to M. Collins-Rector et al., entitled “Targeting Advertising Using Web Pages with Video” and U.S. Pat. No. 6,282,713 ('713) to T. Kitsukawa et al., entitled “Method and Apparatus for Providing On-Demand Electronic Advertising.” The '398 and “713 references allow the user to select various products displayed on the video device and further information about that particular selected product will then appear on the video device. However, these devices do not interact with a printer. Also, these devices cannot be utilized with all types of audio/video devices.

It is also known, in the advertising art, to employ a remote control handset that interacts with the advertising on the video device. Exemplary of such prior art is U.S. Pat. No. 6,292,210 ('210) to I. Gerszberg et al., entitled “Integrated Remote Control and Phone User Interface.” The '210 reference employs a remote control handset that allows the user to interact with the advertising on the video device in order to get more information about the product being advertised. Again, this reference does not disclose the use of a printer that is interactively connected to the audio/video device. Also, this device cannot be used with all types of audio/video devices.

It is apparent from the above that there exists a need in the art for an interactive system which allows the audio/video device to interact with a printer such that a user is able to print out desired information that the user has heard/seen on the audio/video device, but which at the same time allows the printer to interact with all types of audio/video devices. It is a purpose of this invention to fulfill this and other needs in the art in a manner more apparent to the skilled artisan once given the following disclosure.

### SUMMARY OF THE INVENTION

Generally speaking, this invention fulfills these needs by providing a method for interactive communication between an audio/video device, a printer, and a user, wherein the method comprises the steps of: a user hears/sees programming on an audio/video device; the user selects desired material from the programming to be printed; the desired material is downloaded by a printer; and the desired material is printed by the printer.

In certain preferred embodiments, the audio/video device can be, but is not limited to, a radio, a television, a computer, a DVD player, a CD player, a VHS tape player, a cassette tape player or the like. Also, the programming can be, but is not limited to, a song, a radio show, a television program, a movie or the like. Finally, the desired material can be, but is not limited to, advertisements, coupons, discounts, rebates, lyrics, scripts, lists of similar products and/or services, closed captioning or the like.

In another further preferred embodiment, the printer and audio/video device are connected to the central port. In this manner, the printer is constantly receiving information about the programming that the user is hearing/seeing by constantly downloading the information that is ready to be printed. When the user desires further information about a particular product, for example, which is being advertised in the programming, the user merely clicks once on a remote control and that advertisement is downloaded and printed by the printer. If the user does not print this information during the corresponding program, the file is replaced by the supplementary information associated with the next program.

The preferred interactive communication system, according to this invention, offers the following advantages: ease-of-use; ability to be used with all types of audio/video devices; interaction between the audio/video device, the user, and the printer; and one-click downloading/printing of selected programming. In fact, in many of the preferred embodiments, these factors of ease-of-use, ability to be used with all types of audio/video devices, interaction between the audio/video device, user and printer, and one-click downloading/printing are optimized to an extent that is considerably higher than heretofore achieved in prior, known interactive communication systems.

The above and other features of the present invention, which will become more apparent as a description proceeds, are best understood by considering the following detailed description in conjunction with the accompanying drawing figures, wherein like characters represent like parts throughout the several views and in which:

### BRIEF DESCRIPTION OF THE DRAWINGS

FIG. 1 is a flowchart that illustrates a method for interactive communication between an audio/video device, a user, and a printer, according to one embodiment of the present invention; and

FIG. 2 is a flowchart that illustrates a method for downloading/printing information by the printer, according to another embodiment of the present invention.

### DETAILED DESCRIPTION OF THE INVENTION

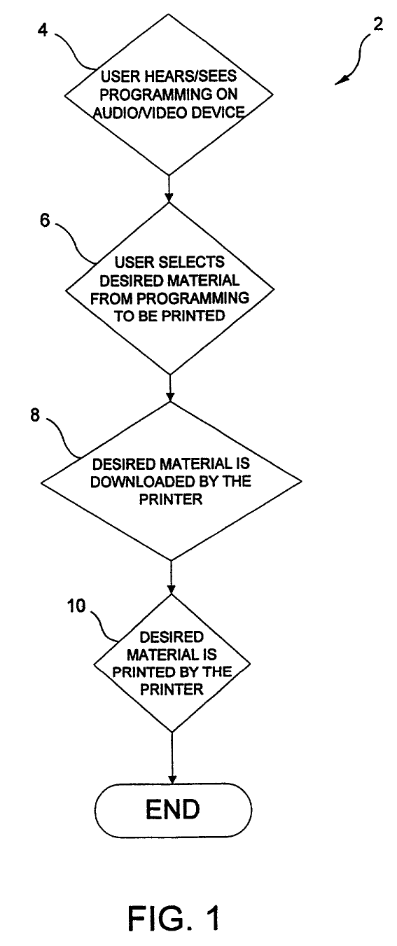

With reference to FIG.1, there is illustrated one preferred embodiment for use of the concepts of this invention. As shown in FIG.1, method 2 for interactively communicating between an audio/video device, a printer, and a user is illustrated. In method 2, the user hears/sees programming on an audio/video device (step 4) and the user selects desired material, for example, an advertisement, to be printed (step 6). A printer then downloads the advertisement (step 8) and prints the advertisement (step 10).

It is to be understood that the audio/video device can be, but is not limited to, a radio, a television, a computer, a DVD player, a CD player, a VHS tape player, a cassette tape player or the like. It is also to be understood that the programming can be, but is not limited to, a song, a radio show, a television program, a movie or the like. It is to be further understood that the desired material can be, but is not limited to, advertisements, coupons, discounts, rebates, lyrics, scripts, lists of similar products and/or services, closed captioning or the like. Finally, is to be understood that the printer is equipped with a conventional computing device that allows the printer to read computer-readable data.

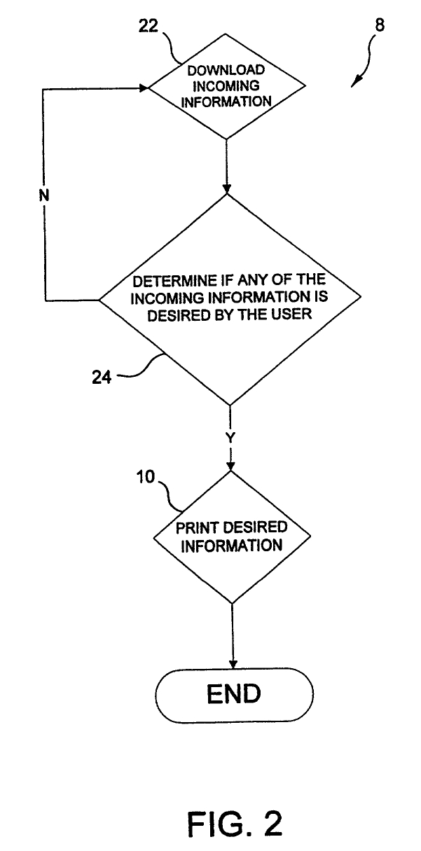

With respect to the operation of method 2, a conventional printer is conventionally connected to a conventional central port such as through a hard wire connection or a wireless connection. Also, similarly connected to this central port is the audio/video device. As programming is coming into the audio/video device, this same programming is also coming into the printer in the form of a computer-readable file, for example, a PostScript® file. See, for example, step 8 in FIG. 2. When the user sees/hears something in the programming, for example, an advertisement, the user merely clicks once on a print button located on a remote control device and the advertisement is downloaded and printed by the printer (steps 24 and 10 in FIG. 2). In this manner, the printer is constantly receiving information regarding the programming being viewed/heard a user and the printer downloads/prints the desired material from the programming by constantly downloading the information that is ready to be printed (step 22 in FIG. 2). If the user does not print this information during the corresponding program, the file is replaced by the supplementary information associated with the next program.

In another preferred embodiment of the operation of method 2, due to the fact that the printer interactively communicates with the audio/video device, the printer is provided with information regarding the channel/station the user is watching/hearing. This allows for the printer to be only connected to the Internet, while the audio/video device is connected to, for example, an antenna. In this manner, the printer is connected to a program being played on the Internet that is in sync with the same program being heard/shown on the audio/video device. Again, the user merely clicks once on the print button located on the remote control device and the desired portion is downloaded/printed by the printer. In this situation, the desired portion of the program that is to be downloaded/printed by the printer provides a Web address to the printer. The printer accesses that Web address in order to download the desired portion and subsequently print the desired portion.

An interesting feature of the present invention can be found in the printing of closed captioning. It is well known that video programming can include closed captioning for a variety of reasons. However, audio programming, such as a radio show, does not. The present invention allows the user to download/print closed captioning, if desired by the user. In this manner, if the user is watching a television show and the user was not able to hear and/or record, for example, the advertisement, the user can merely select that advertisement, including all the closed captioning associated with that advertisement, and have it downloaded and printed by the printer.

Once given the above disclosure, many other features, modifications or improvements will become apparent to the skilled artisan. Such features, modifications or improvements are, therefore, considered to be a part of this invention, the scope of which is to be determined by the following claims.

What is claimed is:

1. A method for interactive communication between an audio/video device, a printer, and a user, comprising the steps of:
a user hears/sees programming on an audio/video device;
said user selects desired material from said programming to be printed;
said desired material is downloaded by a printer; and
said desired material is printed by said printer.

2. The method, as in claim 1, wherein said selecting step is further comprised of the step of:
operating a remote control device.

3. The method, as in claim 2, wherein said operating step is further comprised of the step up:
clicking a print button located substantially on said remote control device.

4. The method, as in claim 1, wherein said downloading step is further comprised of the step of:
storing a computer-readable file of said desired material in said programming; and
reading said computer-readable file by said printer when said user selects said desired material to be printed.

5. The method, as in claim 1, wherein said downloading step is further comprised of the step of:
providing a Web address with said desired material in said programming; and
accessing said Web address by said printer when said user selects said desired material to be printed.

6. The method, as in claim 1, wherein said audio/video device is further comprised of:
a radio.

7. The method, as in claim 1, wherein said audio/video device is further comprised of:
a television.

8. The method, as in claim 1, wherein said audio/video device is further comprised of:
a computer.

9. The method, as in claim 1, wherein said programming is further comprised of:
a radio show.

10. The method, as in claim 1, wherein said programming is further comprised of:
a song.

11. The method, as in claim 1, wherein said programming is further comprised of:
a television show.

12. The method, as in claim 1, wherein said programming is further comprised of:
a movie.

13. The method, as in claim 1, wherein said desired material is further comprised of:
an advertisement.

14. The method, as in claim 1, wherein said desired material is further comprised of:
lyrics.

15. The method, as in claim 1, wherein said desired material is further comprised of:
a script.

16. The method, as in claim 1, wherein said desired material is further comprised of:
closed captioning.

17. A program storage medium readable by a printer, tangibly embodying a program of instructions executable by the printer to perform the steps of:
a user hears/sees programming on an audio/video device;
said user selects desired material from said programming to be printed;
said desired material is downloaded by a printer; and
said desired material is printed by said printer.

18. The method, as in claim 17, wherein said selecting step is further comprised of the step of:
operating a remote control device.

19. The method, as in claim 17, wherein said downloading step is further comprised of the step of:
storing a computer-readable file of said desired material in said programming; and
reading said computer-readable file by said printer when said user selects said desired material to be printed.

20. The method, as in claim 17, wherein said downloading step is further comprised of the step of:
providing a Web address with said desired material in said programming; and
accessing said Web address by said printer when said user selects said desired material to be printed.
